(19) United States
(12) Patent Application Publication
(10) Pub. No.: US 2013/0277230 A1
(43) Pub. Date: Oct. 24, 2013

(54) WATER CLEANING AND SANITISING APPARATUS

(71) Applicants: Mark Knipe, Burleigh Heads (AU); Scott Sawyer, Burleigh Heads (AU)

(72) Inventors: Mark Knipe, Burleigh Heads (AU); Scott Sawyer, Burleigh Heads (AU)

(73) Assignee: PURAPOOL PTY LTD, Burleigh Heads, QLD (AU)

(21) Appl. No.: 13/882,739

(22) PCT Filed: Oct. 27, 2011
(86) PCT No.: PCT/AU2011/001375

§ 371 Date: Jul. 11, 2013

(30) Foreign Application Priority Data
Nov. 1, 2010 (AU) 2010904861

(51) Int. Cl. C02F 1/467

(52) U.S. Cl. CPC C02F 1/4672
USPC 205/744; 204/269; 204/229.4; 205/742; 205/759

(57) ABSTRACT

Apparatus for sanitizing a water stream comprises a first electrolysis cell which produces ions with algaecidal and bactericidal properties and a second electrolysis cell which oxidizes water to produce hydrogen peroxide. The first cell has copper electrodes and the second cell has titanium electrodes and the polarity of the electrodes is periodically reversed at a frequency of from three to nine minutes. Air is introduced into the stream prior to entering the cells.

### FIELD OF THE INVENTION

This invention relates to apparatus for keeping water clean and free of disease carrying organisms, especially for use in swimming pools.

### BACKGROUND OF THE INVENTION

It should be noted that reference to the prior art herein is not to be taken as an acknowledgement that such prior art constitutes common general knowledge in the art.

Patent Application PCT/AU2004/103912 discloses an apparatus comprising ionization means to produce ions having an algaecidal or bactericidal effect into the liquid, ultrasonic cleaning means to introduce sound waves into the liquid and electronic oxidation means to increase the oxidation reduction potential of the liquid, wherein the ionization means, the ultrasonic cleaning means and the electronic oxidation means are operated simultaneously for a period to clean and sanitise the liquid in the absence of added salt, chlorine or other chemicals.

The ionization means comprises electrodes of the alloy 85% copper, 10% zinc and 5% silver and is claimed to generate ions which have an algaecidal or bactericidal effect. In addition the copper and silver ions are claimed to maintain the conductivity of the water without the addition of chemicals, particularly chlorine, and without the operation of a salt water chlorination device.

However the inventors of the present invention have found that this prior art apparatus does require the addition of salt for effective operation. Further they have found that acid must be added to the water to lower pH which rises to unacceptable levels with the operation of the system. Accordingly a pool using this apparatus requires constant monitoring with the addition of chemicals to keep it free of living organisms and in pH balance. It has also been found that the configuration of the ionization cell following the electrolysis cell in the direction of flow as disclosed in PCT/AU2004/103912 is not optimum in relation to the sanitation process.

European patent No 0841305 describes a complex two stage electrolysis cell that requires an ion exchange membrane to separate the electrodes thus creating an anode compartment and a cathode compartment where generation of cathodic electrolytic products from electrolytes in the cathode compartment can then advantageously be passed through an anode compartment of a second cell to achieve the desired oxidant products including hydrogen peroxide.

Clearly it would be advantageous It is therefore an object if a water cleaning and sanitizing apparatus could be devised that helped to at least ameliorate some of the shortcomings described above. In particular it would be advantageous of the present invention to provide a water cleaning and sanitizing apparatus which does not require the addition of chemicals or at least reduces the use of chemicals in a swimming pool.

### STATEMENT OF THE INVENTION

In accordance with a first aspect, the present invention provides an apparatus for sanitizing a stream of water comprising a first electrolysis cell with a common feed which produces ions with algaecidal and bactericidal properties and a second electrolysis cell with a common feed which oxidizes water to produce hydrogen peroxide independently of the first electrolysis cell.

Preferably the first cell has copper electrodes and the second cell has titanium electrodes coated with electrocatalytic metal oxides.

Preferably the polarity of the electrodes of both cells is periodically reversed at a frequency of from three to nine minutes.

Preferably air is introduced into the water prior to entering the electrolysis cells.

Preferably the air is introduced by means of a venturi intake.

Alternatively compressed air may be injected by a compressor.

Preferably the second cell contains an ultrasonic pulse generator.

Preferably the operation of the electrolysis cells and the ultrasonic pulse generator are controlled by a central programmable controller.

In accordance with a further aspect, the present invention provides a process for sanitizing a stream of water, the process comprising: providing a first electrolysis cell with a common feed for producing ions with algaecidal and bactericidal properties; providing a second electrolysis cell with a common feed for oxidizing water to produce hydrogen peroxide; wherein the hydrogen peroxide is produced in the second electrolysis cell independently of the first electrolysis cell.

Preferably, the process may further comprise providing the first electrolysis cell with copper electrodes and providing the second electrolysis cell with titanium electrodes with an electrocatalytic coating. The process may further comprise reversing the polarity of the electrodes periodically at a frequency of three to nine minutes.

Preferably, the process may further comprise providing the second electrolysis cell with an ultrasonic pulse generator.

Preferably, the process may further comprise providing a central programmable controller to control the electrolysis process of the first and second electrolysis cells.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

FIG. 1 is schematic of a swimming pool cleaning and sanitizing apparatus and

FIG. 2 is an isometric view of an electrolysis cell of the apparatus.

### DETAILED DESCRIPTION OF THE INVENTION

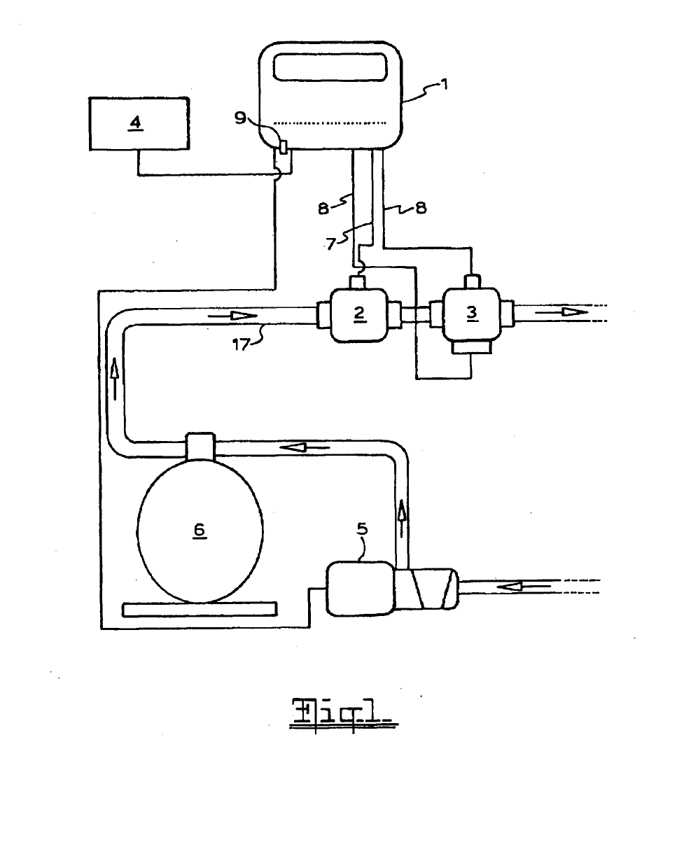

The schematic FIG. 1 shows a pump 5 drawing water from a swimming pool (not shown) and pumping it through a sand filter 6. The latter filter 6 uses a glass filtration medium which removes dead algae, bacteria and dirt from the water which then passes through two electrolysis cells 2 and 3 connected in series and back to the pool. FIG. 1 also shows a common feed into cell 2 and a common feed out of cell 2 and then into cell 3. A venturi air intake is located in the flow at 17 prior to cell 2.

Cell 2 contains two pure copper electrodes the operating anode of which releases from 0.3 to 0.5 ppm of copper ions Cu++ into the water to control algae and bacteria. Cell 3 contains two pure titanium electrodes with electrocatalytic metal oxide coating which in operation generate hydrogen (H+), oxygen (O—) and hydroxyl (OH—) ions from water (H₂O) molecules. Hydrogen peroxide (H₂O₂), which is a powerful sanitizing agent, is formed from the reduction of dissolved oxygen in the water.

Hydrogen Peroxide is specifically formed as a reduction product at the cathode of cell 3 by the electrocatalytic reduction of dissolved oxygen with water to form

H₂O₂ i.e. O₂+2e⁻+2H₂O→2H₂O₂

Chlorine may also be formed in small amounts and this will occur especially when salt is added in increasing proportion. However cells 2 and 3 are specifically configured to favor the generation of hydrogen peroxide which is also enhanced by the introduction of air into the flow at 17.

FIG. 1 also shows that the two electrolysis cells 2, 3 do not use of an ion exchange membrane in order to achieve separation of the cathodic and anodic reaction products. Therefore the two electrolytic cells 2 and 3 are used to decompose chemical compounds by means of the application of electrical energy to the electrodes without any separation of the electrodes or any need for an ion exchange membrane. As is also illustrated in FIG. 1 the present invention discloses a configuration for the exploitation of complementary but separate electrolytic reaction components—i.e. the generation of bactericidal metal ions in the first cell, to complement the oxidative products produced in the second cell.

The electrolysis process in cells 2 and 3 is controlled by controller 1 which draws power from a 240 volt mains supply 4 to provide direct current to cells 2 and 3 via cables 7 and 8. Circuit breaker 9 isolates controller 1 from supply 4 in the event of an electrical fault occurring. Controller 1 is programmed to reverse the polarity of both the copper and platinum electrodes in six minute cycles of operation. This cyclic reversal eliminates mineral build up on the electrode plates and increases their life.

An extension 10 at the base of cell 3 houses a generator (not shown) which pulses ultrasonic pressure waves through the water flowing in cell 3. Operation of the generator is controlled by controller 1 via cable 8 which can vary frequency and intensity of the ultrasonic waves to optimize destruction of parasites such as giardia and cryptosporidium.

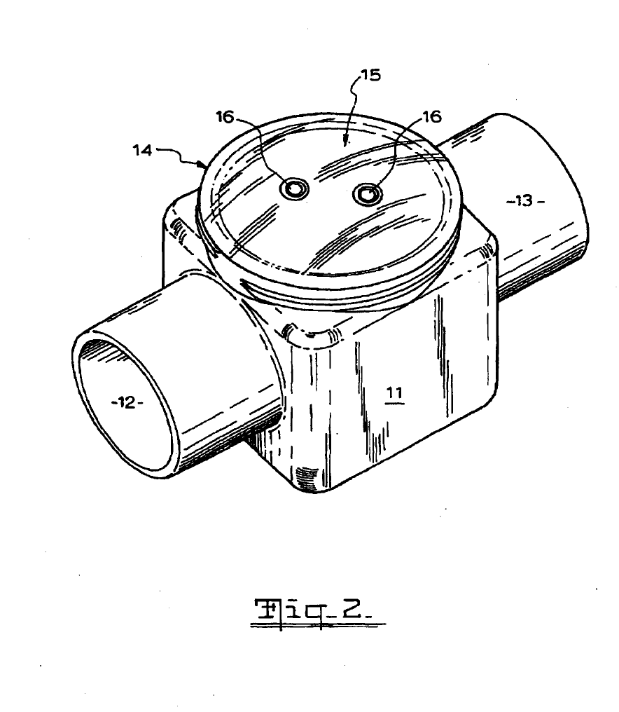

FIG. 2 shows the construction of cells 2 and 3 which have a generally cubic hollow body 11 with entry pipe 12 and exit pipe 13. The top of cells 2 and 3 is formed as a threaded necked opening and mating collar 14 screws onto it thereby retaining transparent cover 15. U shaped electrolysis plates (not visible) slot into body 11 and electrical terminals (not shown) extend from the plates through holes 16 in cover 15. Collar 14 forms a water tight seal with body 11 and holes 16 are sealed with rubber grommets around the terminals. Accordingly cells 2 and 3 are water tight and pool water does not leak from them.

Although the system operates effectively without the addition of chemicals, it is advantageous to add small amounts of magnesium and potassium salts. The latter have a “softening” effect on the water and magnesium and potassium chloride produce residual chlorine by ionization in the electrolysis cells for countries where a minimum chlorine content is required in pool water.

### TEST RESULTS

Test 1. One thousand litres of municipal supply water with a chloride concentration of <10 ppm was recycled using a typical swimming pool pump through the subject apparatus comprising catalytic coated titanium electrodes and ultrasonic cell in series. After 2 hours a residual of 1 ppm H₂O₂ was achieved.

Test 2. One thousand litres of municipal supply water with a chloride concentration of <10 ppm was recycled using a typical swimming pool pump through the subject apparatus comprising catalytic coated titanium electrodes and ultrasonic cell in series. Air was introduced at low flow (˜20 l/minute) through an inlet prior to passage of the water through the electrolysis and ultrasonic cells. After 3 hours a residual of 2 ppm H₂O₂ was achieved.

Test 3. One thousand litres of municipal supply water with a chloride concentration of <10 ppm was recycled using a typical swimming pool pump through the subject apparatus comprising catalytic coated titanium electrodes and ultrasonic cell in series. 167 ppm of Sodium Bicarbonate, and 500 ppm of Magnesium Chloride were added to the solution. Air was introduced at low flow (˜20 l/minute) through an inlet prior to passage of the solution through the electrolysis and ultrasonic cells. After 40 minutes a residual of 1 ppm H₂O₂, and 0.6 ppm Chlorine was achieved.

It will be obvious that the apparatus of the present invention requires minimal addition of chemicals to pool water which results in lower maintenance costs than prior art systems. Further since hydrogen peroxide is a highly effective and odorless oxidising agent, water treated by the system will be freer of contaminating organisms than those systems which rely on residual chlorine which has an unpleasant odor.

### ADVANTAGES

The current invention provides for simpler and lower cost of construction and operation by using a first electrolytic cell without any membrane or barrier (to prevent mixing of electrode products), for dissolution of copper from electrodes in the first cell followed by a second electrolysis cell for generation of oxidants including hydrogen peroxide, without the need of an ion exchange membrane using a single stage electrolytic reaction.

### VARIATIONS

It will be realized that the foregoing has been given by way of illustrative example only and that all other modifications and variations as would be apparent to persons skilled in the art are deemed to fall within the broad scope and ambit of the invention as herein set forth. Throughout the description and claims of this specification the words “comprise” and variations of that word such as “comprises” and “comprising” are not intended to exclude other additives components integers or steps.

1. Apparatus for sanitizing a stream of water comprising a first electrolysis cell with a common feed which produces ions with algaecidal and bactericidal properties and a second electrolysis cell with a common feed which oxidizes water to produce hydrogen peroxide independently of the first electrolysis cell.

2. The apparatus of claim 1, wherein the first cell has copper electrodes and the second cell has titanium electrodes with an electrocatalytic coating.

3. The apparatus of claim 1, wherein air is introduced into the stream prior to entering the electrolysis cells.

4. The apparatus of claim 3, wherein the air is introduced by means of a venturi inlet.

5. The apparatus of claim 3, wherein the air is introduced by a compressor.

6. The apparatus of claim 2, wherein the polarity of the electrodes is periodically reversed at a frequency of from three to nine minutes.

7. The apparatus of claim 2, wherein the second cell contains an ultrasonic pulse generator.

8. The apparatus of claim 1 which is controlled by a central programmable controller.

9. The apparatus of claim 1, wherein the cells are generally cubic hollow bodies with opposing inlet and outlet pipes into which U shaped electrolysis plates are slotted through an opening transverse to the flow and made watertight by a screw top.

10. The apparatus of claim 9, wherein one cell has an ultrasonic pulse generator built into its base.

11. The apparatus of claim 9, further comprising terminals carrying power to the electrolysis plates, passing through the screw top and sealed with grommets.

12. A process for sanitizing a stream of water, the process comprising:
providing a first electrolysis cell with a common feed for producing ions with algaecidal and bactericidal properties;
providing a second electrolysis cell with a common feed for oxidizing water to produce hydrogen peroxide, wherein the hydrogen peroxide is produced in the second electrolysis cell independently of the first electrolysis cell.

13. The process of claim 12, further comprising providing the first electrolysis cell with copper electrodes and providing the second electrolysis cell with titanium electrodes with an electrocatalytic coating.

14. The process of claim 13, further comprising reversing the polarity of the electrodes periodically at a frequency of three to nine minutes.

15. The process of claim 13 further comprising providing the second electrolysis cell with an ultrasonic pulse generator.

16. The process of claim 15, further comprising controlling the electrolysis process of the first and second electrolysis cells with a central programmable controller.

17. The process of claim 14, further comprising controlling the electrolysis process of the first and second electrolysis cells with a central programmable controller.

18. The process of claim 13, further comprising controlling the electrolysis process of the first and second electrolysis cells with a central programmable controller.

19. The process of claim 12, further comprising controlling the electrolysis process of the first and second electrolysis cells with a central programmable controller.
